(19) United States
(12) Patent Application Publication
(10) Pub. No.: US 2026/0050504 A1
(43) Pub. Date: Feb. 19, 2026

(54) METHOD AND SYSTEM FOR DETECTING A HARMFUL SHIFT IN A MACHINE LEARNING MODEL

(71) Applicant: JPMorgan Chase Bank, N.A., New York, NY (US)

(72) Inventors: Salim AMOUKOU, London (GB); Tom BEWLEY, London (GB); Saumitra MISHRA, London (GB); Freddy LECUE, Mamaroneck, NY (US); Daniele MAGAZZENI, London (GB); Manuela VELOSO, New York, NY (US)

(73) Assignee: JPMorgan Chase Bank, N.A., New York, NY (US)

(21) Appl. No.: 18/806,366

(22) Filed: Aug. 15, 2024

(51) Int. Cl. G06F 11/07; G06N 20/00

(52) U.S. Cl. CPC G06F 11/0772; G06N 20/00

(57) ABSTRACT

A method and system for detecting harmful shift in a machine learning (ML) model associated with unlabeled data utilized by the ML model. The method includes implementing an error estimator model with regressor algorithm and training the error estimator model with a first portion of a labeled calibration dataset. The method further includes computing, by the trained error estimator model, an error estimation threshold based on a second portion of the labeled calibration dataset; predicting a performance of the ML model by detecting the harmful shift via the trained error estimator model analyzing the unlabeled data over a predetermined time period and determining a proportion of estimated errors associated with the unlabeled data over the predetermined time period that exceeds the error estimation threshold; and generate an alert when the proportion of estimated errors exceeds the error estimation threshold.

### BACKGROUND

### 1. Field of the Disclosure

This technology generally relates to methods and systems for detecting a harmful shift in a machine learning (ML) model associated with unlabeled data utilized by the ML model.

### 2. Background Information

Machine learning (ML) models are frequently used to analyze a large amount of data and generate predictive analytics regarding the large amount of data, wherein such ML models are operating in a production status, i.e., active operating status. However, when deploying the ML model in a production status, it may be common to encounter changes in data distribution that may have an impact on the error distribution of the ML model's performance. That is, certain shifts in the data distributions may have a detrimental impact on the ML model's performance, whereas other shifts have a minimal (i.e., benign) impact on the ML model's performance. Traditional measures of shift are unable to distinguish determinantal and benign cases. Therefore, it is imperative to determine when shifts in the data distribution negatively affects the ML model's performance.

Typically, conventional techniques rely on two-sample or batch testing, which involves comparing the statistical properties of a new dataset from a production environment with those of a control sample. These techniques have inherent limitations, as the sample size is pre-specified, i.e., with known labels. This is a problem because the necessary amount of data to detect any given shift is unknown beforehand. Furthermore, in real-world scenarios, data typically arrive sequentially over time, and shifts may occur gradually. Traditional batch testing is ill-suited to these sequential contexts, as it does not accommodate the collection of additional data for re-testing without adjusting for multiple testing, which may lead to diminished power.

Accordingly, there is a need for techniques to detect a harmful shift in a machine learning (ML) model associated with unlabeled data utilized by the ML model.

### SUMMARY

The present disclosure, through one or more of its various aspects, embodiments, and/or specific features or sub-components, provides, inter alia, various systems, servers, devices, methods, media, programs, and platforms for detecting a harmful shift in a machine learning (ML) model associated with unlabeled data utilized by the ML model.

According to an aspect of the present disclosure, a method for detecting a harmful shift in a machine learning (ML) model associated with unlabeled data utilized by the ML model is provided. The method may be implemented by at least one processor. The method may include: implementing an error estimator model with a regressor algorithm; training the error estimator model with a first portion of a labeled calibration dataset; computing, by the trained error estimator model, an error estimation threshold based on a second portion of the labeled calibration dataset; predicting a performance of the ML model by the detecting the harmful shift via the trained error estimator model analyzing the unlabeled data over a predetermined time period and determining a proportion of estimated errors associated with the unlabeled data over the predetermined time period that exceeds the error estimation threshold; and generating an alert when the proportion of estimated errors exceeds the error estimation threshold.

The error estimator model with the regressor algorithm comprises at least one from among an extreme gradient boosted (XGBoost) decision tree ML model with supervised learning, a random forest ML model, and a ML model capable of performing error estimation with regression.

The computing of the error estimation threshold enables a classification of the unlabeled data into a first category of a high true error and a second category of a low true error, wherein the first category of the high true error corresponds to true errors at a threshold of at least greater than a median of the true errors in the second portion of the labeled calibration dataset, and wherein the second category of the low true error corresponds to the errors at a threshold of less than the median.

The exceeding the error estimation threshold comprises exceeding the first category of the high true error.

The predicting comprises utilizing a predetermined sequential test with a first hypothesis and a second hypothesis.

The first hypothesis comprises a null hypothesis that the harmful shift has not occurred and wherein the second hypothesis comprises a hypothesis that the harmful shift has occurred.

Additionally, the first hypothesis correlates with a first statistical probability function in relation to an empirical quantile associated with true errors for maintaining a low rate of false positives, and wherein the second hypothesis comprises a second statistical probability function with a resulting value of approximately one.

The low rate of false positives in the first statistical probability function is modeled by a predetermined false discovery proportion (FDP) function and wherein the second statistical probability function is modeled by a predetermined power function.

The predicting of the performance of the ML model occurs while the ML model is operating in a production environment.

The first portion of the labeled calibration dataset comprises a first half of an entirety of the labeled calibration dataset and the second portion of the labeled calibration dataset comprises a second half of the entirety of the labeled calibration dataset.

According to another embodiment, a computing apparatus for detecting a harmful shift in a machine learning (ML) model associated with unlabeled data utilized by the ML model is provided. The computing apparatus comprising: a processor; a memory; a display; and a communication interface coupled to each of the processor, the memory, and the display.

The processor is configured to: implement an error estimator model with a regressor algorithm; train the error estimator model with a first portion of a labeled calibration dataset; compute, by the trained error estimator model, an error estimation threshold based on a second portion of the labeled calibration dataset; predict a performance of the ML model by the detecting the harmful shift via the trained error estimator model analyzing the unlabeled data over a predetermined time period and determining a proportion of estimated errors associated with the unlabeled data over the predetermined time period that exceeds the error estimation threshold; and generate an alert when the proportion of estimated errors exceeds the error estimation threshold.

The error estimator model with the regressor algorithm comprises at least one from among an extreme gradient boosted (XGBoost) decision tree ML model with supervised learning, a random forest ML model, and a ML model capable of performing error estimation with regression.

The computing of the error estimation threshold based on the second portion of the labeled calibration dataset enables a classification of the unlabeled data into a first category of a high true error and a second category of a low true error, wherein the first category of the high true error corresponds to true errors at a threshold of at least greater than a median of the true errors in the second portion of the labeled calibration dataset, wherein the second category of the low true error corresponds to the errors at a threshold of less than the median, and wherein the exceeding the error estimation threshold comprises exceeding the first category of the high true error.

The predicting comprises utilizing a predetermined sequential test with a first hypothesis and a second hypothesis, wherein the first hypothesis comprises a null hypothesis that the harmful shift has not occurred, and wherein the second hypothesis comprises a hypothesis that the harmful shift has occurred.

The first hypothesis correlates with a first statistical probability function in relation to an empirical quantile associated with true errors for maintaining a low rate of false positives, wherein the second hypothesis comprises a second statistical probability function with a resulting value of approximately one, wherein the low rate of false positives in the first statistical probability function is modeled by a predetermined false discovery proportion (FDP) function, and wherein the second statistical probability function is modeled by a predetermined power function.

According to yet another embodiment, non-transitory computer readable storage medium storing instructions for detecting a harmful shift in a machine learning (ML) model associated with unlabeled data utilized by the ML model is provided. The non-transitory computer readable storage medium comprising executable code which, when executed by a processor, causes the processor to: implement an error estimator model with a regressor algorithm; train the error estimator model with a first portion of a labeled calibration dataset; compute, by the trained error estimator model, an error estimation threshold based on a second portion of the labeled calibration dataset; predict a performance of the ML model by the detecting the harmful shift via the trained error estimator model analyzing the unlabeled data over a predetermined time period and determining a proportion of estimated errors associated with the unlabeled data over the predetermined time period that exceeds the error estimation threshold; and generate an alert when the proportion of estimated errors exceeds the error estimation threshold.

The error estimator model with the regressor algorithm comprises at least one from among an extreme gradient boosted (XGBoost) decision tree ML model with supervised learning, a random forest ML model, and a ML model capable of performing error estimation with regression.

The computing of the error estimation threshold based on the second portion of the labeled calibration dataset enables a classification of the unlabeled data into a first category of a high true error and a second category of a low true error, wherein the first category of the high true error corresponds to true errors at a threshold of at least greater than a median of the true errors in the second portion of the labeled calibration dataset, wherein the second category of the low true error corresponds to the errors at a threshold of less than the median, and wherein the exceeding the error estimation threshold comprises exceeding the first category of the high true error.

The predicting comprises utilizing a predetermined sequential test with a first hypothesis and a second hypothesis, wherein the first hypothesis comprises a null hypothesis that the harmful shift has not occurred, and wherein the second hypothesis comprises a hypothesis that the harmful shift has occurred.

The first hypothesis correlates with a first statistical probability function in relation to an empirical quantile associated with true errors for maintaining a low rate of false positives, wherein the second hypothesis comprises a second statistical probability function with a resulting value of approximately one, wherein the low rate of false positives in the first statistical probability function is modeled by a predetermined false discovery proportion (FDP) function, and wherein the second statistical probability function is modeled by a predetermined power function.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for detecting a harmful shift in a machine learning (ML) model associated with unlabeled data utilized by the ML model.

FIG. 4 illustrates a flowchart of a process diagram according to an embodiment for detecting a harmful shift in a machine learning (ML) model associated with unlabeled data utilized by the ML model.

FIG. 5 illustrates examples of different types of shifts that may affect a machine learning (ML) model according to an embodiment.

FIG. 6 shows an illustration of a high-level overview of the process for detecting a harmful shift in a machine learning (ML) model associated with unlabeled data utilized by the ML model.

FIG. 7 illustrates an example of a shift detection in a machine learning (ML) model.

### DETAILED DESCRIPTION

When deploying a model, e.g., a machine learning model in a production environment, it may be common to encounter changes in data distribution, such as changes in covariates or concepts in the ML model, which may presently be detected with existing techniques. However, the present techniques do not assess whether shifts in data distribution of the model negatively affects the prediction error of trained models. That is, not all distribution shifts have a harmful impact on model error, but traditional measures of shift are unable to distinguish between harmful and benign cases. Additionally, conventional techniques rely on two-sample or batch testing, which involves comparing the statistical properties of a new dataset from a production environment with those of a control sample. These techniques have inherent limitations, requiring that the sample size be pre-specified. This is a problem because the necessary amount of data to detect any given shift is unknown beforehand. Furthermore, in real-world scenarios, data typically arrive sequentially over time, and shifts may occur gradually. As such, traditional batch testing is ill-suited to these sequential contexts, as it does not accommodate the collection of additional data for retesting without adjusting for multiple testing, which may lead to diminished power. Additionally, present techniques necessitates that the ground truth labels of production data are available. However, in many practical scenarios, such as medical diagnosis or credit scoring or financial transactions where predictions are made about future events, immediate access to labels in production is not feasible.

The present application addresses these limitations in the status quo by enabling detection of a harmful shift in a machine learning (ML) model associated with unlabeled data utilized by the ML model as described below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

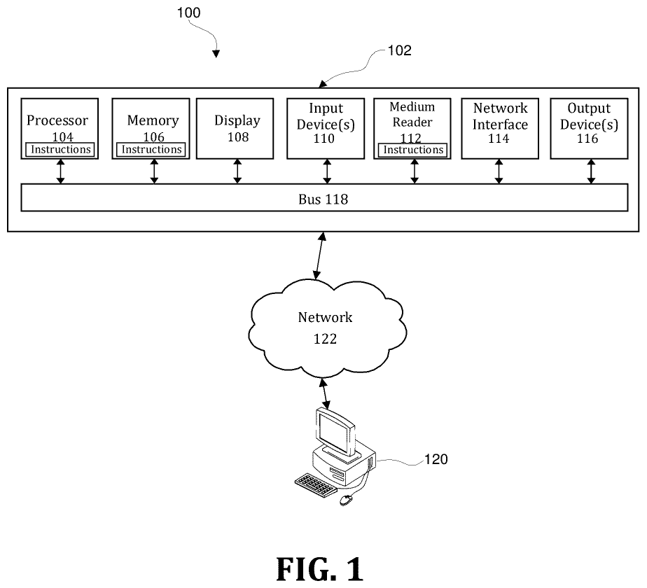

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray® disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, Bluetooth®, Zigbee®, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems for detecting a harmful shift in a machine learning (ML) model associated with unlabeled data utilized by the ML model.

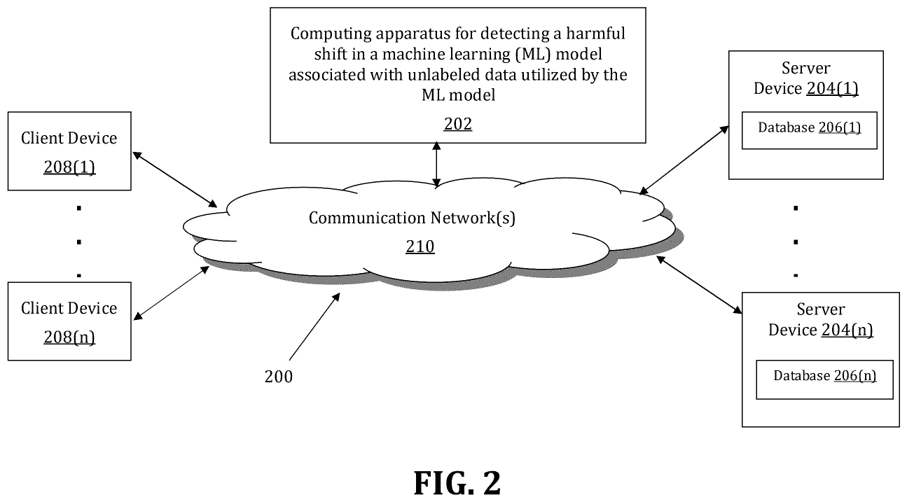

Referring to FIG. 2, FIG. 2 illustrates a network diagram of a network environment 200 for implementing a method for detecting a harmful shift in a ML model associated with unlabeled data utilized by the ML model may be illustrated. In an embodiment, the method may be executable on any networked computer platform, such as, for example, a personal computer (PC).

The method for detecting a harmful shift in a ML model associated with unlabeled data utilized by the ML model may be implemented by a computing apparatus 202 that implements a harmful shift detection in the ML model associated with unlabeled data utilized by the ML model. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for detecting a harmful shift in a ML model associated with unlabeled data utilized by the ML model.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including for example, one or more public, private, or cloud networks.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or JavaScript® Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

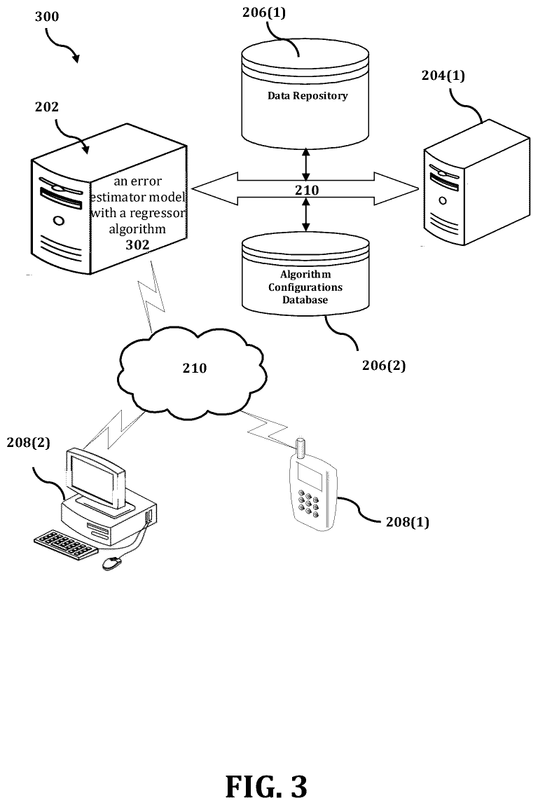

The computing apparatus 202 may be described and illustrated in FIG. 3 as including an error estimator model with a regressor algorithm 302, although it may include other rules, algorithms, policies, modules, databases, or applications, for example. As will be described below, the error estimator model with the regressor algorithm 302 may be configured to implement a method for detecting a harmful shift in a machine learning (ML) model associated with unlabeled data utilized by the ML model.

FIG. 3 illustrates a diagram of a system environment 300 for implementing a method for detecting a harmful shift in a machine learning (ML) model associated with unlabeled data utilized by the ML model by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository 206(1) and an algorithm configurations database 206(2). The error estimator model with the regressor algorithm 302 may be configured to access these databases for implementing the detecting of a harmful shift in a ML model associated with unlabeled data utilized by the ML model.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

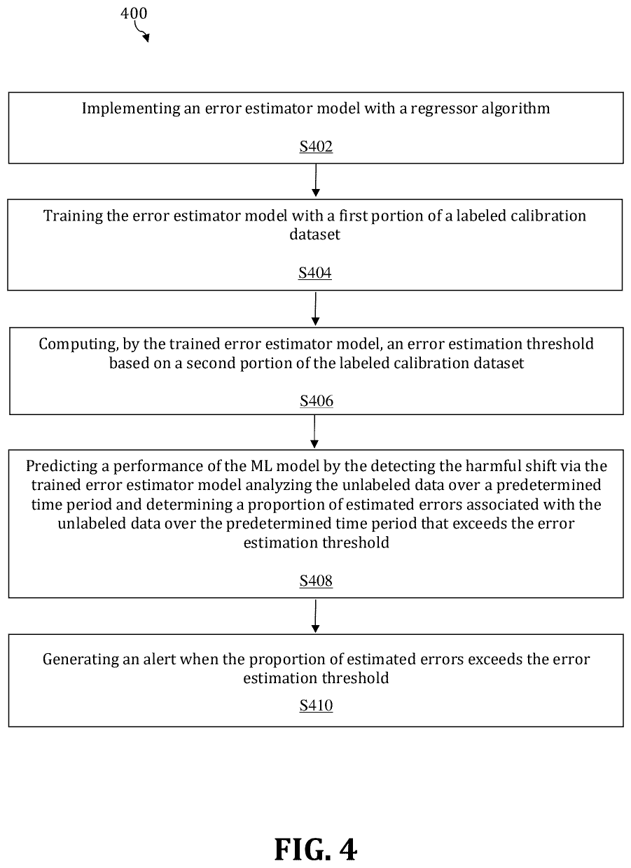

Upon being started, the error estimator model with the regressor algorithm 302 executes a process implementing a method for detecting a harmful shift in a ML model associated with unlabeled data utilized by the ML model, i.e., wherein the shift in the data distributions may have a detrimental impact on the ML model's performance by impacting the error distribution of the ML model a detrimental manner that negatively affects the performance of the ML model. A process for automating for detecting a harmful shift in a ML model associated with unlabeled data utilized by the ML model may be generally indicated at flowchart 400 in FIG. 4.

FIG. 4 illustrates a flowchart of a process diagram 400 of a process for implementing a method for detecting a harmful shift in a machine learning (ML) model according to an embodiment. At step S402 of the flowchart process 400, the computing apparatus 202 implements an error estimator model with a regressor algorithm 302. In an embodiment, the error estimator model with the regressor algorithm 302 may be, but is not limited to, an extreme gradient boosted (XGBoost) decision tree ML model with supervised learning, a random forest ML model, or any other ML model capable of performing error estimation with regression.

At step S404, the computing apparatus 202 may train the error estimator model, i.e., the error estimator model with the regressor algorithm 302, with a first portion of a labeled calibration dataset. The first portion of the labeled calibration dataset comprises a first half of an entirety of the labeled calibration dataset. Additionally, the labeled calibration dataset may be part of a larger dataset comprising training dataset, test dataset, and labeled calibration dataset. For instance, the larger dataset may be partitioned into 60% training dataset, 20% test dataset, and 20% labeled calibration dataset. This partitioning is an example and is not intended to limit the claim features.

In an example, a problem statement may be initially defined wherein X and Y may denote input and label spaces, respectively. For a predictive model f:X→Y, it may be defined that a measurable and bounded loss function [symbol] :Y²→ϵ may be selected for monitoring purposes. It may be assumed, without loss of generality, that ϵ=[0, 1]. The error associated with a specific instance (X, Y)∈X×Y, drawn from the joint distribution P(X,Y)=P_{X}P_{Y|X}, may be represented by the random variable E= [symbol] (f(X), Y). The probability distribution of the error may be expressed as P_{E}. The term θ:P(ϵ)→Θ may be introduced as a mapping from probability distributions on ϵ to a parameter space Θ. This mapping could, for instance, map the distribution to its mean or certain quantiles.

The focus of the problem statement is not on shifts in covariates or labels, but rather on changes in the model's error distribution P_{E}. This concept is regarding P_{E} denoting error shift, which may be caused by both covariate and label shifts since P_{E} may vary due to changes in either P_{X} (while the conditional label distribution P_{Y|X} remains constant) or P_{Y} (while keeping P_{X|Y} constant).

The first portion of the labeled calibration dataset comprises a first half of an entirety of the labeled calibration dataset. Wherein a labeled holdout set (or labeled calibration data set)

$$Dn = {\{ ( {X}_{i}^{0} , {Y}_{i}^{0} ) \}}_{1}^{n}$$

may be independently and identically drawn from a source distribution

$${P}_{( X , Y )}^{0} = {P}_{X}^{( 0 )} {P}_{Y \vert X}^{( 0 )}$$

as a reference dataset. Additionally, a sequence of unlabeled observations (Xₜ)_{t≥1} may be drawn from a time-varying target distribution

$${P}_{( X , Y )}^{( t )}$$

encountered in production. The error distribution at time t may be denoted as P_{E}^{(t)}, and it may be assumed that the support of the error distribution in production may be a subset of that of the source, i.e., supp (P_{E}^{(t)}⊆supp (P_{E}⁽⁰⁾). Thus, for some time T∈N∪{∞}:

$${P}_{( X , Y )}^{( t )} = {P}_{( X , Y )}^{0} , ∀ t < T and {P}_{( X , Y )}^{( t )} \neq {P}_{( X , Y )}^{( t )} , ∀ t \geq T .$$

At step S406, the computing apparatus 202 may compute, by the trained error estimator model, an error estimation threshold based on a second portion of the labeled calibration dataset. Wherein the second portion of the labeled calibration dataset comprises a second half of the entirety of the labeled calibration dataset. And the second portion may be used to find target quantiles such as empirical quantiles α and \hat{α}. For example, determining α∈(0.5, 1), \hat{α}∈(0, 1) at which maximal detection power may be achieved while keeping the false discovery proportion (FDP), i.e., false positives, at a low value such as below 0.2. In an example, the target quantile may be approximately located at the median, i.e., α=0.5.

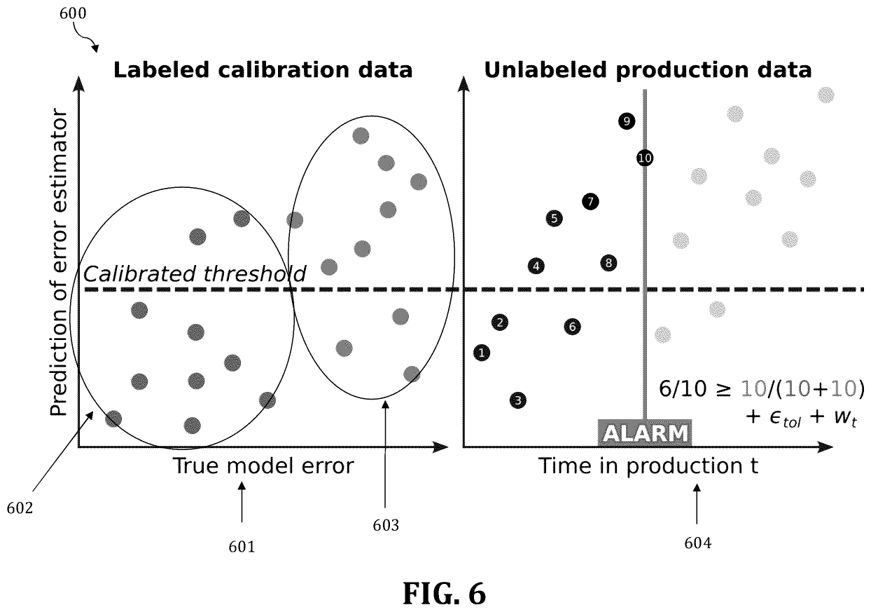

Continuing with step S406, the computing of the error estimation threshold enables a classification of the unlabeled data into a first category of a high true error and a second category of a low true error. Wherein the first category of the high true error corresponds to true errors at a threshold of at least greater than a median of the true errors in the second portion of the labeled calibration dataset, and wherein the second category of the low true error corresponds to the errors at a threshold of less than the median. The high true error and the low true error are shown in FIG. 6. In an example, the first category of high true error corresponds to the set/region where most observations from the second portion of the labeled calibration set have a true error greater than a specified threshold, wherein the specified threshold may be set to be at least greater than a median of the true errors in the second portion of the calibration set. This threshold may be selected to maximize the number of observations in the region while keeping the number of low-error observations below a certain alpha (e.g., a chosen alpha value of 0.2).

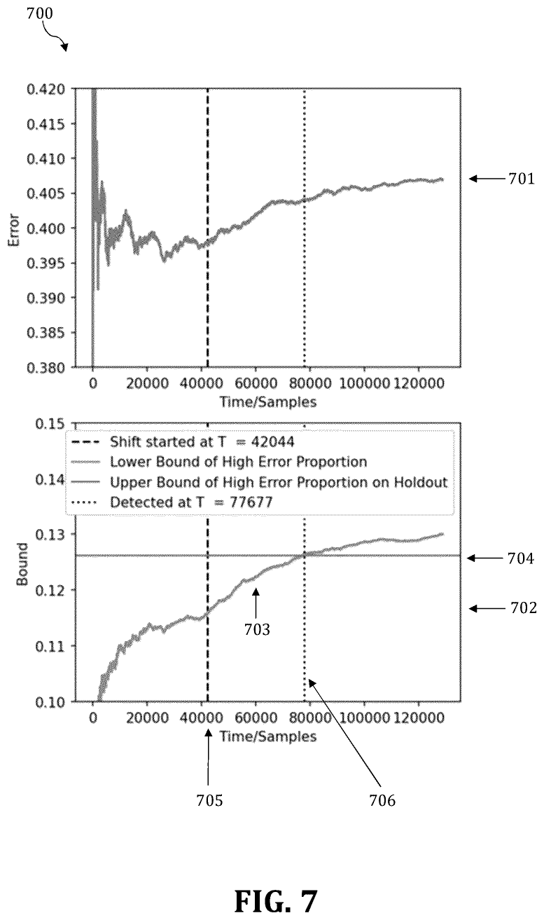

At step S408, the computing apparatus 202 may predict a performance of the ML model by the detecting of the harmful shift via the trained error estimator model analyzing the unlabeled data over a predetermined time period and determining a proportion of estimated errors associated with the unlabeled data over the predetermined time period that exceeds the error estimation threshold. The detecting and predicting being performable on a continuous basis, i.e., i.e., analyzing the unlabeled data on a continuous basis for time t<∞ for the presence of a shift, and if so, predict whether this shift is harmful. The analyzing of the unlabeled label comprises analyzing millions of the unlabeled data utilized by the ML model over a predetermined time period. In an example as the analysis may be performed over a predetermined time period comprising any predetermined time period of interest, e.g., seconds, minutes, hours, or days. That is, the time scale is flexible and may be set to any unit and the process at step S408 is adaptative such that it may be performed for one sample per time period or a plurality of samples per time period. An example time period is shown in FIG. 7.

Continuing with step S408, the exceeding the error estimation threshold comprises exceeding the first category of the high true error. Additionally, the predicting of the performance of the ML model occurs while the ML model is operating in a production environment, i.e., in an active operating status that is not training.

Continuing with step S408, the predicting comprises utilizing a predetermined sequential test with a first hypothesis and a second hypothesis. The first hypothesis comprises a null hypothesis (H₀) that the harmful shift has not occurred and wherein the second hypothesis comprises a hypothesis that the harmful shift has occurred (H₁). The first hypothesis H₀ correlates with a first statistical probability function ( [symbol] _{H}_{₀}) in relation to an empirical quantile (α) associated with true errors for maintaining a low rate of false positives, and the second hypothesis H₁ comprises a second statistical probability function ( [symbol] _{H}_{₁}) with a resulting value of approximately one. The low rate of false positives in the first statistical probability function is modeled by a predetermined false discovery proportion (FDP) function and wherein the second statistical probability function is modeled by a predetermined power function. The FDP function and predetermined power function are described below with regards to FIG. 6.

The predetermined sequential test may be an α-level sequential with finite data that may be defined as a mapping Φ:

$${U}_{k = 1}^{∞} {X}^{k} \to \{ 0 , 1 \} ,$$

which at time t may use the first t observations X₁, . . . , Xₜ to output 0 (no harmful shift; continue production) or 1 (harmful shift; stop production) that may provably control the false alarm rate as modeled by [symbol] _{H}_{₀} as shown below and have high power as modeled by [symbol] _{H}_{₁} as shown below. That is, the mapping may be modeled by the following two functions as shown below.

$${ℙ}_{{H}_{0}} \{ ∃ t \geq 1 : Φ ( {X}_{1} , … , {X}_{t} ) = 1 \} \leq α$$

$${ℙ}_{{H}_{1}} \{ ∃ t \geq 1 : Φ ( {X}_{1} , … , {X}_{t} ) = 1 \} \approx 1$$

Thus, the probability of no harmful shift is modeled by the probability function with H₀ and the probability of a harmful shift is modeled by the probability function with H₁.

The first hypothesis comprises a null hypothesis H₀ that the harmful shift has not occurred may be generally modeled as shown below.

$${H}_{0} : ∀ t \geq 1 , \frac{1}{t} {\sum }_{i = 1}^{t} {E}_{t} ( f ) \leq {E}_{Test} ( f ) + {ϵ}_{tol}$$

Or modeled in a more specific equation as shown below.

$${H}_{0} : ∀ t \geq 1 , ( \frac{1}{t} {\sum }_{k = 1}^{t} θ ( {P}_{E}^{( k )} ) ) \leq θ ( {P}_{E}^{( 0 )} ) + {ϵ}_{tol}$$

Or as a special case of the specific equation, wherein the special case is shown below.

$${H}_{1} : ∃ t \geq T : \frac{1}{t} {\sum }_{k = 1}^{t} {ℙ}_{{P}^{( k )}} ( Z = 1 ) > {ℙ}_{{P}^{( 0 )}} ( Z = 1 ) + {ϵ}_{tol}$$

Note the similarities between the equations. The term Eₜ(f) may denote production error at time t, the term E_{Test}(f) may denote error on a pre-production test set, and the term ϵtol being a tolerance level. In the specific equation, it may be specified that the E terms have been replaced with the probability distribution of the error (P_{E}), which was described above. The term

$$( \frac{1}{t} {\sum }_{k = 1}^{t} θ ( {P}_{E}^{( k )} ) )$$

may represent the cumulative risk or the running risk, which provides insights into the evolution of the error over time. In the special case, the [symbol] _{P} means that the probability may be taken under distribution P. The special case essentially checks whether the true error quantile corresponding to the value q has shifted to the right from the source distribution to production of the general by defining the

$$θ ( {P}_{E}^{( k )} )$$

in the specific equation to equal [symbol] _{P(k)}(Z=1) in the special case.

The second hypothesis H₁ comprises a hypothesis that the harmful shift has occurred may be modeled generally as shown below.

$${H}_{1} : ∃ t \geq 1 , \frac{1}{t} {\sum }_{i = 1}^{t} {E}_{t} ( f ) > {E}_{Test} ( f ) + {ϵ}_{tol}$$

Or modeled in a more specific equation as shown below.

$${H}_{1} : ∃ t \geq T : ( \frac{1}{t} {\sum }_{k = 1}^{t} θ ( {P}_{E}^{( k )} ) ) > θ ( {P}_{E}^{( 0 )} ) + {ϵ}_{tol}$$

Or as a special case of the specific equation, wherein the special case is shown below.

$${H}_{1} : ∃ t \geq T : \frac{1}{t} {\sum }_{k = 1}^{t} {ℙ}_{{P}^{( k )}} ( Z = 1 ) > {ℙ}_{{P}^{( 0 )}} ( Z = 1 ) + {ϵ}_{tol}$$

Note the similarities in the equations. The term Eₜ(f) may denote production error at time t, the term E_{Test}(f) being error on a pre-production test set, and the term ϵtol being a tolerance

$$( \frac{1}{t} {\sum }_{k = 1}^{t} θ ( {P}_{E}^{( k )} ) )$$

level. In the specific equation, it may be specified that the E terms have been replaced with the probability distribution of the error (P_{E}), which was described above. The term may represent the cumulative risk or the running risk, which provides insights into the evolution of the error over time. In the special case, the [symbol] _{P} means that the probability may be taken under distribution P. The special case essentially checks whether the true error quantile corresponding to the value q has shifted to the right from the source distribution to production of the general by defining the

$$θ ( {P}_{E}^{( k )} )$$

in the specific equation to equal [symbol] _{P(k)}(Z=1) in the special case.

Regarding the two hypotheses H₀ and H₁, intuitively, H₀ holds if the running risk remains below that of the source distribution (+ϵtol) throughout production at any time, and H₁ holds if this condition was violated.

At step S410, the computing apparatus 202 may generate an alert when the proportion of estimated errors exceeds the error estimation threshold.

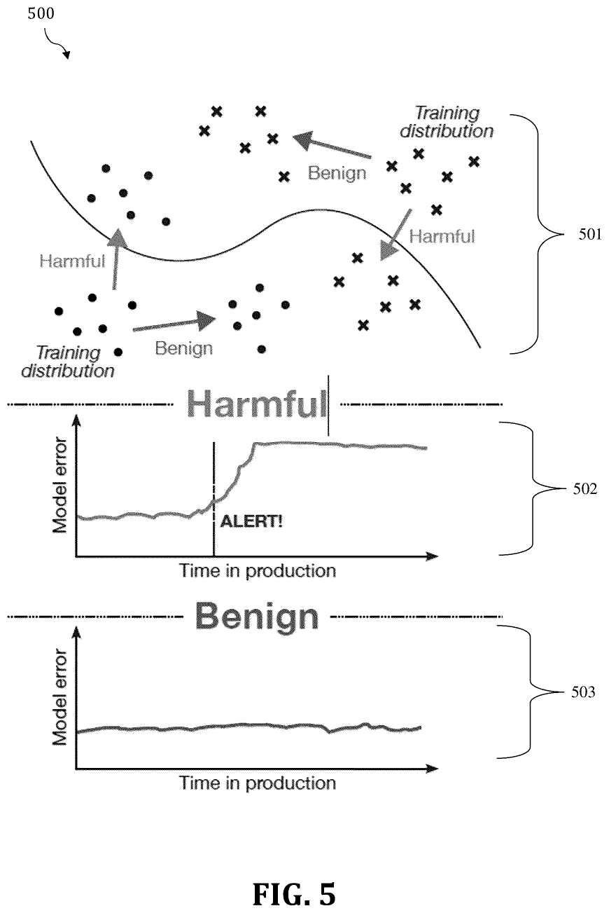

FIG. 5 illustrates examples 500 of different types of shifts that may affect a machine learning (ML) model according to an embodiment. In 501, distributions of training data are shown. A first example distribution of training data is denoted as by Xs and a second example distribution of training data is denoted by circles. In the first example, it may be seen that there is a benign shift in the distribution of the training data to the left of the original distribution location. Notice that while there is a shift, the shift is benign, wherein a benign shift occurs when the data does not cross the line. In contrast, a shift over the line results in a harmful shift. This may be seen in the first example by the Xs crossing the line. Similarly, in the second example, a benign shift occurs when the distribution of the training data has shifted to the right from the original distribution location. Whereby, again, the shift is a benign shift when the data does not cross the line. In contrast, a harmful shift occurs in the second example when the distribution of the training data as denoted by the circles crosses the line.

Continuing with FIG. 5, a sequential harmful shift example 502 is depicted. As shown at 502, a shift in the distribution of data occurs while the ML model is operating in a production environment over time, wherein the shift results in an increased model error, e.g., ML model error, as is tracked on the y-axis. Note that the model error begins at some point in time and that as this model error begins to rise, i.e., the model's prediction error begins to increase, it is desirable to generate an alert warning that a harmful sequential shift is being detected in the model, e.g., the ML model, and its performance. It is preferable to generate this warning before the model, e.g., the ML model, operates wholly within the high model error state as denoted by the plateau in the distribution of data that occurs at some high model error value as shown after the alert. This is preferable because then changes and corrections may be made to the model to prevent it from operating with the high model error. As such, the alert should immediately be generated as a sequential harmful shift is detected, as denoted in this sequential harmful shift example 502 at point where there is a rise in the y-axis resulting in a changing slope.

Continuing with FIG. 5, a benign sequential shift example 503 is depicted. As shown at 503, there is none to minimal shift in the distribution of data that occurs while the ML model is operating in a production environment over time. Notice that the shift here has none to minimal change in the model, e.g., ML model, as is tracked on the y-axis. That is, the model error remains almost essentially the same with almost none to minimal variations in the model error. As such, this example shows a benign sequential shift such that while there may be a shift in the distribution of data, the shift does not have a harmful impact on the model's operation and performance.

FIG. 6 shows an illustration of a high-level overview 600 of the process for detecting a harmful shift in a machine learning (ML) model associated with unlabeled data utilized by the ML model. An error estimator model with the regressor algorithm 302 may be fitted to a ML model to predict a model error associated with the primary ML model in order to evaluate the performance and operation of the ML model. The first diagram 601 shows a labeled calibration data set denoted by the data points as represented by the dots to calibrate an estimated error threshold (denoted by the dashed line - - - ) that separates/classifies observations based on low true error 602 and high true error 603. The first diagram 601 and the descriptions related to it are merely illustrative and are not intended to limit the claim features.

The fitting of the error estimator model with the regressor algorithm 302 may to the ML model involves the use of an estimated error from the error estimator model with the regressor algorithm 302, wherein the error estimator model with the regressor algorithm 302 may be denoted as \hat{r}:X→E. This model may be trained using a portion of a holdout set (or calibration data set) to predict the true error of the ML model. As a result, a statistic may be formulated to deal with unlabeled samples as follows:

$${\hat{Φ}}_{m} ( {X}_{1} , … , {X}_{t} ) = \{ \hat{L} ( \hat{r} ( {X}_{1} ) , … , \hat{r} ( {X}_{t} ) ) > \hat{U} ( \hat{r} ( {X}_{1}^{0} ) , … , \hat{r} ( {X}_{n}^{0} ) ) + {ϵ}_{tol} \} .$$

The statistic Φ enables a detection of when and where a shift occurs in the manner of an explainable artificial intelligence (XAI) related with the error estimator model with the regressor algorithm 302.

To determine and ensure that \hat{r} may be sufficiently accurate, changes of certain quantiles of the error (a) may be tracked. It may be noted that \hat{r} need not be accurate to 100% accuracy in order to still effectively distinguish between data points with the lowest and highest errors in a dataset. As such, \hat{r} merely needs to be sufficiently accurate and this accuracy may be tracked by assigning scores that, while not exact, still preserve the ordinal relationship among data points. For example, if \hat{r}(·) has grasped some underlying patterns to predict the errors, and if E₍ₖ₎ and E₍ₗ₎ represent the k-th and l-th ranked errors and are significantly distinct, then it would be highly probable that \hat{r}(X₍ₖ₎≤\hat{r}(X₍₁₎). Thus, enabling a preservation of the ranking order among observations with notably different errors than to predict their exact error value and a focus on the relative ranking of errors rather than their specific magnitudes of error.

In a further example of this process, a larger dataset may be partitioned as described above, e.g., into 60% training dataset, 20% test dataset, and 20% labeled calibration dataset. Again, this partitioning is an example and is not intended to limit the claim features. Half of the calibration set may be used to train the error estimator model with a regressor algorithm 302, e.g., a model with a XGBoost regressor, to estimate the error of the model such a ML model. It is noted that any other error estimator model capable of performing error estimation with regression may also be used.

An analysis of the distribution of the predicted errors within the remaining 50% of the labeled calibration dataset is performed by dividing the remaining 50% of the labeled calibration dataset/labeled holdout set at the median (or 0.5-quantile) of the true errors, denoted by Q(α,

$${\{ {E}_{l}^{0} \}}_{l = 1}^{n} ) ,$$

α=0.5. That is, it may be defined that:

$${D}^{( - )} = \{ \hat{r} ( {X}_{i}^{0} ) : {E}_{i}^{0} \leq Q ( α , {\{ {E}_{l}^{0} \}}_{l = 1}^{n} ) , i ∈ 1 , … , n \} and \\ {D}^{( + )} = \{ \hat{r} ( {X}_{i}^{0} ) : {E}_{i}^{0} > Q ( α , {\{ {E}_{l}^{0} \}}_{l = 1}^{n} ) , i ∈ 1 , … , n \} .$$

Wherein D (−) and D (+) represent the predicted errors of observations for which the true errors are, respectively, below and above the median.

This analysis as described above may be formalized such that given the holdout set and the error estimator \hat{r}, a target empirical quantile may be identified for the true errors Q(α,

$${\{ {E}_{l}^{0} \}}_{l = 1}^{n} ) ,$$

α∈(0, 1), and determine a threshold using the empirical quantiles of the estimated errors \hat{q}=Q(\hat{α}, {\hat{r}(Xᵢ):Xᵢ∈Dₙ)}, \hat{α}∈(0, 1) such that the selector S_{\hat{r},\hat{α}}: [symbol] →{0, 1} defined as S_{\hat{r},\hat{α}}(X)=1_{\hat{r}(X)>\hat{q}} correctly finds most of the observations having true error above the quantile Q(α,

$${\{ {E}_{l}^{0} \}}_{l = 1}^{n} ) .$$

In an example, the selector may be the XGBoost regressor, although any other regressor model capable of performing error estimation with regression may be used. The primary objective here being to effectively locate observations within the data set H₁={(X, Y)∈X×Y:Z=1} with Z=1 {E>Q(α,

$${\{ {E}_{l}^{0} \}}_{l = 1}^{n} ) \}$$

that ensures high power and a controlled false discovery proportion (FDP), defined for the holdout dataset as shown below. That is, the predetermined false discovery proportion (FDP) function and the predetermined power function may be modeled as shown below.

$$Power = \frac{{\sum }_{i = 1}^{n} 1 [ {S}_{\hat{r} , \hat{α}} ( {X}_{i}^{0} ) = 1 ] 1 [ {Z}_{i}^{0} = 1 ]}{{\sum }_{i = 1}^{n} 1 [ {Z}_{i}^{0} = 1 ]} ,$$

$$FDP = \frac{{\sum }_{i = 1}^{n} 1 [ {S}_{\hat{r} , \hat{α}} ( {X}_{i}^{0} ) = 1 ] 1 [ {Z}_{i}^{0} = 0 ]}{{\sum }_{i = 1}^{n} 1 [ {S}_{\hat{r} , \hat{α}} ( {X}_{i}^{0} ) = 1 ]} .$$

Experimental analysis of the error estimator model with a regressor algorithm 302 shows a capability of detecting a significant portion of observations with errors above certain true empirical quantiles, e.g., particularly near the 0.5 and 0.9 quantiles, while maintaining an FDP of just above 0.2. Thus, practically, the maximum FDP may be set to 0.2 and a selection of the combination of α∈(0.5, 1), \hat{α}∈(0, 1) with a maximum power that would not violate the FDP threshold. Additionally, while α may be set to any value, for practical purposes, a may generally be set at or above 0.5 to enable high power and low FDP.

To ensure effective operation of the error estimator model with a regressor algorithm 302 and that the FDP does not escalate, several conditions should be stipulated.

A first condition may be that for any t≥1,

$${ℙ}_{{P}^{( t )}} ( Z = 0 \vert {S}_{\hat{r} , \hat{α}} ( X ) = 1 ) \leq {ℙ}_{{P}^{( 0 )}} ( Z = 0 \vert {S}_{\hat{r} , \hat{α}} ( X ) = 1 ) .$$

This condition enables the use the number of observations having S_{\hat{r},\hat{α}}(X)=1
as an indicator of the harmful shift intensity in production because the FDP in production would be under control, and would be generally be smaller than that observed in the source data. A second condition provides another way of controlling the false alarm, i.e., the FDP. Wherein for any t≥1,

$${ℙ}_{{P}^{( t )}} ( {S}_{\hat{r} , \hat{α}} ( X ) = 1 , Z = 0 ) \leq {ℙ}_{{P}^{( 0 )}} ( {S}_{\hat{r} , \hat{α}} ( X ) = 1 , Z = 0 ) .$$

Essentially, the second condition provides in practical terms that the area representing low-error observations selected by the error estimator model with a regressor algorithm 302 when the model, e.g., the ML model, in production should not surpass that of the area observed under the source data distribution. In essence, the proportion of observations selected in production would generally be at or below the level of the source data being analyzed.

Consequently, a lower marginal error in the holdout set, [symbol] ₚ₍₀₎(S_{\hat{r},\hat{α}}(X)=1, Z=0), implies a higher likelihood of a similarly low marginal error in production, [symbol] _{P(t)}(S_{\hat{r},\hat{α}}(X)=1,Z=0), as it indicates fewer instances of error for the error estimator model with the regressor algorithm 302. An increase in marginal error in production would necessitate a shift targeting specifically those observations with low error.

Additionally, since the error estimator model with the regressor algorithm 302 may be sufficiently accurate to detect changes in quantiles with zero marginal error, then the FDP has been necessarily controlled, as this implies that regardless of the shift, the set of incorrectly selected observations would be empty.

A third condition relates to the error estimator model with the regressor algorithm 302 being sufficiently accurate to detect changes in quantiles with zero marginal error. That is, the error estimator model with the regressor algorithm 302 may be sufficiently accurate to detect changes in quantiles with zero marginal error may be sufficiently accurate such that

$${ℙ}_{{P}_{E}^{( 0 )}} ( {S}_{\hat{r} , \hat{α}} ( X ) = 1 , Z = 0 ) = 0.$$

This condition codifies that there would not be instances in which the error estimator model with the regressor algorithm 302 would incorrectly select an observation as having an error above the target quantile, ensuring that shifts in the data distribution would not lead to an increase in the FDP in production. For instance, it would be possible to have the threshold for the quantile \hat{α} at higher values, e.g., 0.7-1.0, that may correlate with having zero marginal error, but this would come at the cost of reducing the power. Thus, a balancing framework with lower and upper bounds may be used as testing methodology for the error estimator model with the regressor algorithm 302 and the thresholds for the quantiles.

Continuing with the third condition, an example of the lower bound may be:

$$\begin{matrix}\frac{1}{t} {{\sum }_{k = 1}}^{t} {ℙ}_{{P}^{( k )}} ( Z = 1 ) = \frac{1}{t} {{\sum }_{k = 1}}^{t} {ℙ}_{{P}^{( k )}} ( {S}_{\hat{r} , \hat{α}} ( X ) = 1 , Z = 1 ) \\ + {ℙ}_{{P}^{( k )}} ( {S}_{\hat{r} , \hat{α}} ( X ) = 0 , Z = 1 )\end{matrix}$$

$$Therefore ,$$

$$\begin{matrix}\frac{1}{t} {{\sum }_{k = 1}}^{t} {ℙ}_{{P}^{( k )}} ( Z = 1 ) \geq \frac{1}{t} {{\sum }_{k = 1}}^{t} {ℙ}_{{P}^{( k )}} ( {S}_{\hat{r} , \hat{α}} ( X ) = 1 , Z = 1 ) \\ = \frac{1}{t} {{\sum }_{k = 1}}^{t} {ℙ}_{{P}^{( k )}} ( {S}_{\hat{r} , \hat{α}} ( X ) = 1 ) - {ℙ}_{{P}^{( k )}} ( {S}_{\hat{r} , \hat{α}} ( X ) = 1 , Z = 0 ) \\ \geq \frac{1}{t} {{\sum }_{k = 1}}^{t} {ℙ}_{{P}^{( k )}} ( {S}_{\hat{r} , \hat{α}} ( X ) = 1 ) - {ℙ}_{{P}^{( 0 )}} ( {S}_{\hat{r} , \hat{α}} ( X ) = 1 , Z = 0 )\end{matrix}$$

Wherein the last inequality arises in relation to the second condition. Since both [symbol] _{P(k)}(S_{\hat{r},\hat{α}}(X)=1) and [symbol] _{P}_{⁽⁰⁾}(S_{\hat{r},\hat{α}}(X)=1, Z=0) may be observed in production time, a confidence sequence may be used to construct time-uniform valid bound of these quantities.

Therefore, there exists a [symbol] which may defined as:

$$\begin{matrix}{\hat{L}}_{g} = \frac{1}{t} {{\sum }_{k = 1}}^{t} \{ {S}_{\hat{r} , \hat{α}} ( {X}_{k} ) = 1 \} \\ - \frac{1}{t} {{\sum }_{k = 1}}^{t} \{ {S}_{\hat{r} , \hat{α}} ( {X}_{i}^{0} ) = 1 , {Z}_{i}^{0} = 0 \} - {w}_{t} - {w}_{n}\end{matrix} ,$$

where wₜ, wₙ corresponds to the widths of the lower and upper of

$$( 1 / t ) {\sum }_{k = 1}^{t} {ℙ}_{{P}^{( t )}} ( {S}_{\hat{r} , \hat{α}} ( X ) = 1 ) and {ℙ}_{{P}^{( 0 )}} ( {S}_{\hat{r} , \hat{a}} ( X ) = 1 , Z = 0 ) ,$$

with miscoverage α₁, α₂, respectively, such that for any miscoverage level α_{Tr}=α₁+α₂∈(0, 1),

$$ℙ ( ∀ t \geq 1 : \frac{1}{t} {{\sum }_{k = 1}}^{t} {ℙ}_{{P}^{( k )}} ( Z = 1 ) \geq {\hat{L}}_{q} ) \geq 1 - {α}_{{T}_{r}} .$$

Additionally, in another example, given a holdout set that may be mapped as part of the predetermined sequential test and modeled by the [symbol] _{H}_{₁} function, which was previously described above and presented again below for convenient reference: [symbol] _{H}_{₁} {∃t≥1:Φ(X₁, . . . , Xₜ)=1}≈1, then bounds may also be created regarding the holdout set and the [symbol] _{H}_{₁} function as part of the predetermined sequential test. For instance, an upper bound may similarly be created. That is, the upper bound [symbol] for [symbol] _{P}_{⁰} (Z=1) as follows:

$${\hat{U}}_{q} = \frac{1}{n} {{\sum }_{i = 1}}^{n} \{ {Z}_{i}^{0} = 1 \} + {w}_{n} ,$$

such that for a given miscoverage level as α_{Sr}∈(0, 1), then [symbol] ( [symbol] _{P}_{⁽⁰⁾}(Z=1)≤U_{q})≥1−α_{S}_{ᵣ}.

Therefore, the statistic Φ_{q} may be defined as follows:

$${Φ}_{q} ( {X}_{1} , … , {X}_{t} ) = [ {\hat{L}}_{q} > {\hat{U}}_{q} + {ϵ}_{tol} ] .$$

While Φ_{q} offers a controlled false alarm rate, its power may be limited if the shift would not be a significant shift. The statistic Φ_{q} enables a detection of when and where a shift occurs in the manner of an explainable artificial intelligence (XAI) related with the error estimator model with the regressor algorithm 302.

Noting that [symbol] _{P}_{^{t}} (Z=1) may be lower bounded by [symbol] _{P}_{^{T}}S_{\hat{r},\hat{α}}(X)=1, Z=1, then detecting a change would necessitate this probability to exceed [symbol] _{P}_{⁰}(Z=1). Thus, it may also be proposed that the

$$( 1 / t ) {\sum }_{k = 1}^{t} {ℙ}_{{P}^{( k )}} ( {S}_{\hat{r} , \hat{α}} ( X ) = 1 , Z = 1 )$$

equation be directly compared with the [symbol] _{P}_{⁽⁰⁾}(S_{\hat{r},\hat{α}}(X)=1, Z=1). equation This may lead to a second test with a much higher power, using an upper bound [symbol] for the equation [symbol] _{P}_{⁽⁰⁾}(S_{\hat{r},\hat{α}}(X)=1, Z=1) instead of [symbol] . Wherein the upper bound [symbol] may be defined as:

$${\hat{U}}_{q}^{2} = \frac{1}{n} {{\sum }_{i = 1}}^{n} \{ {S}_{\hat{r} , \hat{α}} ( {X}_{i}^{0} ) = 1 , {Z}_{i}^{0} = 1 \} + {w}_{n} ,$$

and thus, satisfying the following equation:

$$ℙ ( {ℙ}_{{P}^{( 0 )}} ( {S}_{\hat{r} , \hat{α}} ( X ) = 1 , Z = 1 ) \leq {\hat{U}}_{q}^{2} ) \geq 1 - {α}_{{S}_{r}} .$$

Therefore, the second test is defined as:

$${Φ}_{q}^{2} ( {X}_{1} , … , {X}_{t} ) = [ {\hat{L}}_{q} > {\hat{U}}_{q}^{2} + {ϵ}_{tol} ] .$$

Continuing with FIG. 6, the second diagram 604 shows model, e.g., a ML model, operating for a period of time (t) in a production environment. From the distribution of data via the ten data points in 604, it may be seen that six of those data points (namely 4, 5, 7, 8, 9, and 10) occur above the calibrated threshold, which denotes a higher prediction of the error estimator as shown on the y-axis. That is, the error estimator model with a regressor algorithm 302 may track the proportion of estimated errors associated with these data points are likely indicating that a sequential harmful shift in a ML model may be occurring. As such, an alarm may be generated at this point in time (t) warning that the sequential harmful shift in the ML model may be occurring. In the equation shown in the second diagram 604, the 10/(10+10) term may represent: (the data points at 603)/(data points at 602+data points at 603). That is, the term represents: (the high error 603)/(low error 602+high error 603). The term ϵₜₒₗ may represent a tolerance threshold and term wₜ may represent a correction term, wherein these terms help to deal with the sequential setting and account for potential uncertainty in the error estimates. For instance, the correction term we may be used to debias the error estimation model. An alert/alarm may be raised/generated when the data points of the unlabeled data (e.g., the six data points out of a total of 10 data points in this example) exceed the rate of high-error observations in a calibration set plus the tolerance threshold ϵₜₒₗ and the correction term wₜ. Note that in the example in the second diagram, the alarm occurs at time (t)=10. The second diagram 604 and the descriptions related to it are merely illustrative and are not intended to limit the claim features.

FIG. 7 illustrates an example 700 of a sequential shift detection in a machine learning (ML) model. The first diagram 701 shows an example evolution of a model, e.g., a ML model, over time/samples and the error associated with the model at a time/samples of 0 to over 120,000 (120K). Note the increase in error as we proceed further on the x-axis, i.e., as the time/samples increase. Further analysis of the ML model may be performed at time/samples of 42044 and 77677, and further described in the second diagram 702.

Continuing with FIG. 7, the second diagram 702 shows an example analysis of the evolution of a model, e.g., a ML model, by the error estimator model with a regressor algorithm 302 to predict high error proportion associated with the distribution of the data utilized by the model, e.g., the ML model. At time/samples of 42044 (reference label 705), the sequential shift starts. While at time/samples of 77677 (reference label 706), the sequential shift may be detected, wherein this denotes a harmful sequential shift since it correlates with higher error. Note that within the frame of 42044 to 77677, the sequential shift may be seen with the upper bound of high proportion on holdout/calibration data set (reference label 704) and lower bound of high error proportion (reference label 703).

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for detecting a harmful shift in a machine learning (ML) model associated with unlabeled data utilized by the ML model, the method being implemented by a processor, the method comprising:
implementing an error estimator model with a regressor algorithm;
training the error estimator model with a first portion of a labeled calibration dataset;
computing, by the trained error estimator model, an error estimation threshold based on a second portion of the labeled calibration dataset;
predicting a performance of the ML model by the detecting the harmful shift via the trained error estimator model analyzing the unlabeled data over a predetermined time period and determining a proportion of estimated errors associated with the unlabeled data over the predetermined time period that exceeds the error estimation threshold; and
generating an alert when the proportion of estimated errors exceeds the error estimation threshold.

2. The method of claim 1, wherein the error estimator model with the regressor algorithm comprises at least one from among an extreme gradient boosted (XGBoost) decision tree ML model with supervised learning, a random forest ML model, and a ML model capable of performing error estimation with regression.

3. The method of claim 1, wherein the computing the error estimation threshold enables a classification of the unlabeled data into a first category of a high true error and a second category of a low true error,
wherein the first category of the high true error corresponds to true errors at a threshold of at least greater than a median of the true errors in the second portion of the labeled calibration dataset, and
wherein the second category of the low true error corresponds to the errors at a threshold of less than the median.

4. The method of claim 3, wherein the exceeding the error estimation threshold comprises exceeding the first category of the high true error.

5. The method of claim 1, wherein the predicting comprises utilizing a predetermined sequential test with a first hypothesis and a second hypothesis.

6. The method of claim 5, wherein the first hypothesis comprises a null hypothesis that the harmful shift has not occurred and wherein the second hypothesis comprises a hypothesis that the harmful shift has occurred.

7. The method of claim 6, wherein the first hypothesis correlates with a first statistical probability function in relation to an empirical quantile associated with true errors for maintaining a low rate of false positives, and wherein the second hypothesis comprises a second statistical probability function with a resulting value of approximately one.

8. The method of claim 7, wherein the low rate of false positives in the first statistical probability function is modeled by a predetermined false discovery proportion (FDP) function and wherein the second statistical probability function is modeled by a predetermined power function.

9. The method of claim 1, wherein the predicting of the performance of the ML model occurs while the ML model is operating in a production environment.

10. The method of claim 1, wherein the first portion of the labeled calibration dataset comprises a first half of an entirety of the labeled calibration dataset and the second portion of the labeled calibration dataset comprises a second half of the entirety of the labeled calibration dataset.

11. A computing apparatus for detecting a harmful shift in a machine learning (ML) model associated with unlabeled data utilized by the ML model, comprising:
a processor;
a memory;
a display; and
a communication interface coupled to each of the processor, the memory, and the display, wherein the processor is configured to:
implement an error estimator model with a regressor algorithm;
train the error estimator model with a first portion of a labeled calibration dataset;
compute, by the trained error estimator model, an error estimation threshold based on a second portion of the labeled calibration dataset;
predict a performance of the ML model by the detecting the harmful shift via the trained error estimator model analyzing the unlabeled data over a predetermined time period and determining a proportion of estimated errors associated with the unlabeled data over the predetermined time period that exceeds the error estimation threshold; and
generate an alert when the proportion of estimated errors exceeds the error estimation threshold.

12. The computing apparatus of claim 11, wherein the error estimator model with the regressor algorithm comprises at least one from among an extreme gradient boosted (XGBoost) decision tree ML model with supervised learning, a random forest ML model, and a ML model capable of performing error estimation with regression.

13. The computing apparatus of claim 11, wherein the computing the error estimation threshold enables a classification of the unlabeled data into a first category of a high true error and a second category of a low true error,
wherein the first category of the high true error corresponds to true errors at a threshold of at least greater than a median of the true errors in the second portion of the labeled calibration dataset,
wherein the second category of the low true error corresponds to the errors at a threshold of less than the median, and
wherein the exceeding the error estimation threshold comprises exceeding the first category of the high true error.

14. The computing apparatus of claim 11, wherein the predicting comprises utilizing a predetermined sequential test with a first hypothesis and a second hypothesis,
wherein the first hypothesis comprises a null hypothesis that the harmful shift has not occurred, and
wherein the second hypothesis comprises a hypothesis that the harmful shift has occurred.

15. The computing apparatus of claim 14, wherein the first hypothesis correlates with a first statistical probability function in relation to an empirical quantile associated with true errors for maintaining a low rate of false positives,
wherein the second hypothesis comprises a second statistical probability function with a resulting value of approximately one,
wherein the low rate of false positives in the first statistical probability function is modeled by a predetermined false discovery proportion (FDP) function, and
wherein the second statistical probability function is modeled by a predetermined power function.

16. A non-transitory computer readable storage medium storing instructions for detecting a harmful shift in a machine learning (ML) model associated with unlabeled data utilized by the ML model, the non-transitory computer readable storage medium comprising executable code which, when executed by a processor, causes the processor to:
implement an error estimator model with a regressor algorithm;
train the error estimator model with a first portion of a labeled calibration dataset;
compute, by the trained error estimator model, an error estimation threshold based on a second portion of the labeled calibration dataset;
predict a performance of the ML model by the detecting the harmful shift via the trained error estimator model analyzing the unlabeled data over a predetermined time period and determining a proportion of estimated errors associated with the unlabeled data over the predetermined time period that exceeds the error estimation threshold; and
generate an alert when the proportion of estimated errors exceeds the error estimation threshold.

17. The non-transitory computer readable storage medium of claim 16, wherein the error estimator model with the regressor algorithm comprises at least one from among an extreme gradient boosted (XGBoost) decision tree ML model with supervised learning, a random forest ML model, and a ML model capable of performing error estimation with regression.

18. The non-transitory computer readable storage medium of claim 16, wherein the computing the error estimation threshold enables a classification of the unlabeled data into a first category of a high true error and a second category of a low true error,
wherein the first category of the high true error corresponds to true errors at a threshold of at least greater than a median of the true errors in the second portion of the labeled calibration dataset,
wherein the second category of the low true error corresponds to the errors at a threshold of less than the median, and
wherein the exceeding the error estimation threshold comprises exceeding the first category of the high true error.

19. The non-transitory computer readable storage medium of claim 16, wherein the predicting comprises utilizing a predetermined sequential test with a first hypothesis and a second hypothesis,
wherein the first hypothesis comprises a null hypothesis that the harmful shift has not occurred, and
wherein the second hypothesis comprises a hypothesis that the harmful shift has occurred.

20. The non-transitory computer readable storage medium of claim 19, wherein the first hypothesis correlates with a first statistical probability function in relation to an empirical quantile associated with true errors for maintaining a low rate of false positives,
wherein the second hypothesis comprises a second statistical probability function with a resulting value of approximately one,
wherein the low rate of false positives in the first statistical probability function is modeled by a predetermined false discovery proportion (FDP) function, and
wherein the second statistical probability function is modeled by a predetermined power function.
